(19) United States
(12) Patent Application Publication
(10) Pub. No.: US 2010/0132003 A1
(43) Pub. Date: May 27, 2010

(54) Providing Wireless Pathway Adapter Support Via Set-Top Boxes

(76) Inventors: James D. Bennett, Hroznetin (CZ); Jeyhan Karaoguz, Irvine, CA (US)

Correspondence Address: MCANDREWS HELD & MALLOY, LTD, 500 WEST MADISON STREET, SUITE 3400, CHICAGO, IL, 60661, US

(21) Appl. No.: 12/323,253

(22) Filed: Nov. 25, 2008

(51) Int. Cl. H04N 7/173

(52) U.S. Cl. 725/127

(57) ABSTRACT

Internal or external pathway adapters are utilized to enable playing personal media streams via STBs. The personal media streams are forwarded from local and/or remote sources. The personal media sources communicate directly and/or indirectly with the pathway adapters. The pathway adapters support a plurality of wireless and/or wired interfaces. The pathway adapters channelize the received personal media streams to simulate TV channels in TV broadcasts receivable via the STBs. The channelized personal media streams are feed directly and separately into the STB and/or combined with TV broadcast feeds. Management server functionality in the pathway adapters enables interactions with the pathway adapter, to request pathway services and/or to establish routing paths for personal media streams to the pathway adapter, wherein these interactions, are based on webpage-based interfaces and/or dedicated APIs.

### CROSS-REFERENCE TO RELATED APPLICATIONS/INCORPORATION BY REFERENCE

[Not Applicable].

### FEDERALLY SPONSORED RESEARCH OR DEVELOPMENT

[Not Applicable].

### MICROFICHE/COPYRIGHT REFERENCE

[Not Applicable].

### FIELD OF THE INVENTION

Certain embodiments of the invention relate to video processing. More specifically, certain embodiments of the invention relate to a method and system for providing wireless pathway adapter support via set-top boxes.

### BACKGROUND OF THE INVENTION

Television (TV) broadcasts are generally transmitted by television head-ends over broadcast channels, via RF carriers. The TV head-ends may comprise terrestrial TV head-ends, Cable-Television (CATV), and/or satellite TV head-ends. The terrestrial TV head-ends may utilize, for example, a set of terrestrial broadcast channels, which in the U.S. may comprise, for example, channels 2 through 69. The Cable-Television (CATV) broadcasts may utilize an even greater number of broadcast channels, for example up to channel 125. The TV broadcasts comprise transmission of video and/or audio information, wherein the video and/or audio information may be encoded into the broadcast channels via one of plurality of available modulation schemes. The TV Broadcasts may utilize analog and/or digital modulation format. In analog television systems, picture and sound information are encoded into, and transmitted via analog signals, wherein the audio/video information may be conveyed via broadcast signals, via amplitude and/or frequency modulation on the television signal, based on analog television encoding standard. Analog television broadcasters may, for example, encode their signals using NTSC, PAL and/or SECAM analog encoding and then modulate these signals onto a VHF or UHF RF carriers, for example.

In digital television (DTV) systems, television broadcasts may be communicated by terrestrial, cable, and/or satellite head-ends via discrete (digital) signals, utilizing one or more of available digital modulation schemes, which may comprise, for example, QAM, VSB, QPSK, and/or OFDM. The use of digital signals generally requires less bandwidth than analog signals to convey the same amount of information. Accordingly, DTV systems may enable broadcasters to provide more digital channels within the same space otherwise available to analog television systems. In addition, the use of digital television signals may enable broadcasters to provide high-definition television (HDTV) broadcasting and/or to provide other non-television related service via the digital system. Available digital television systems comprise, for example, ATSC, DVB, and/or VSB based systems. Video and/or audio information may be encoded into digital television signals utilizing various video and/or audio encoding and/or compression algorithms, which may comprise, for example, MPEG-2, MPEG-4 AVC, MP3, AC-3, MC, and/or HE-AAC.

Televisions (TVs) may be utilized to display or present broadcasted TV content, and received TV broadcasts may be inputted directly into the TVs, wherein the TVs may be enabled to performed necessary processing operations to extract the audio/video information. Specialized devices referred to as set-top boxes or converters may be utilized to provide necessary processing operations that converts the TV broadcast to signals suitable for processing via the TV. The resulting output from the STB or converter may then be inputted into the TVs via one or more of available types of connectors including, but not limited to, F-connectors, S-video, composite, and/or video component connectors such as HDMI and DVI.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for wireless pathway adapter support via set-top boxes, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram that illustrates a channelized video streaming setup, in accordance with an embodiment of the invention.

FIG. 2A is a block diagram that illustrates an external wireless adapter that is utilized to enable channelized video streaming processing via a satellite set-top box (STB) that support two satellite feeds, in accordance with an embodiment of the invention.

FIG. 2B is a block diagram that illustrates an external wireless adapter that is utilized to enable channelized video streaming processing via a satellite set-top box (STB) that support a single satellite feed, in accordance with an embodiment of the invention.

FIG. 2C is a block diagram that illustrates an internal wireless adapter that is utilized to enable channelized video streaming processing via a satellite set-top box (STB), in accordance with an embodiment of the invention.

FIG. 3 is a flow chart that illustrates use of channelized video streaming system in supporting wireless feed via set-top boxes, in accordance with an embodiment of the invention.

### DETAILED DESCRIPTION OF THE INVENTION

Certain embodiments of the invention may be found in a method and system for wireless pathway adapter support via set-top boxes. In accordance with various embodiments of the invention, a pathway adapter is utilized to enable playing personal media streams via a set-top box (STB). The pathway adapter is integrated within a STB or converter. The personal media streams are forwarded from local and/or remote sources. The personal media sources communicate directly with the pathway adapter, and/or indirectly via intermediate nodes, hubs, switches and/or other devices. The pathway adapter supports a plurality of wireless and/or wired interfaces, including, for example, WLAN and/or WPAN based interfaces. The pathway adapter performs security and/or deciphering of received messaging, carrying the personal media streams, if necessary. The pathway adapter processes the received personal media streams to enable playing them seamlessly via the STB. The processing comprises channelizing the received media streams to simulate TV channels in any TV broadcasts receivable via the STB. The channelized personal media streams are fed directly and separately into the STB, and/or combined and/or multiplexed with TV broadcast feeds received by the STB. The switching between and/or combining of the channelized personal media streams and TV broadcast feeds is performed within pathway adapters, external to the pathway adapters but within the STBs, and/or external to both the STBs and the pathway adapters, via a dedicated device for example. A management server functionality in the pathway adapter enables interactions with the pathway adapter, to request pathway services and/or to establish routing paths for personal media streams from local and/or remote sources to the pathway adapter. The user interactions, via the management server functionality, are based on webpage-based interfaces and/or dedicated APIs.

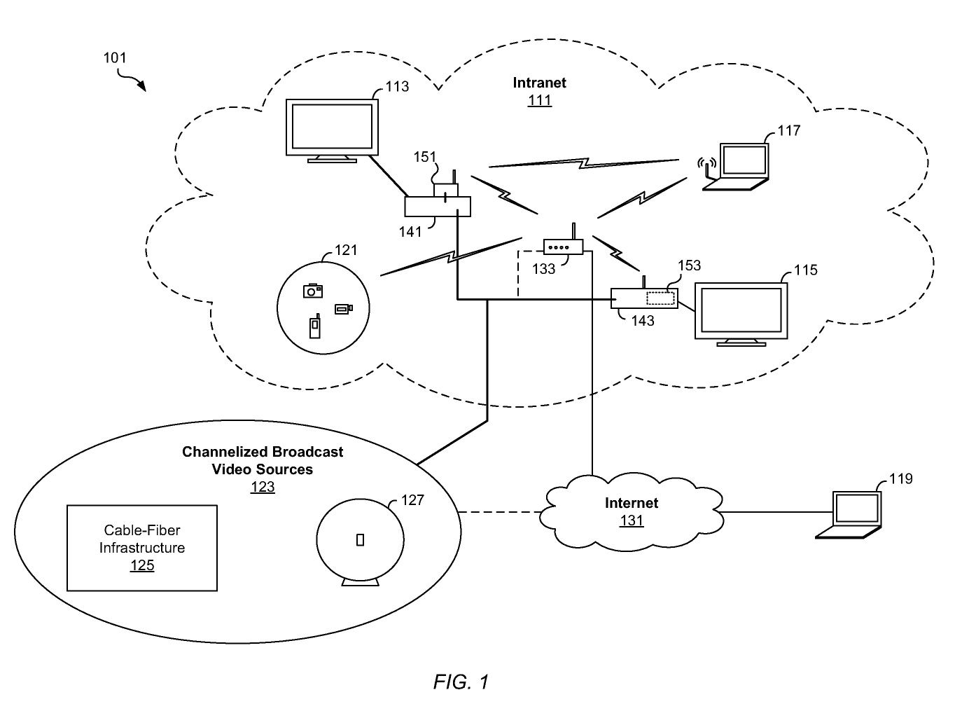

FIG. 1 is a block diagram that illustrates a channelized video streaming setup, in accordance with an embodiment of the invention. Referring to FIG. 1, there is shown a channelized video streaming setup 101, intranet 111, televisions 113 and 115, a local personal computer (PC) 117, a remote PC 119, a plurality of personal media sources 121, a plurality of channelized broadcast video sources 123, a cable-fiber infrastructure 125, and a satellite dish 127. FIG. 1 also shows Internet 131, a hub 133, a first set-top box (STB) 141, a second STB 143, an external pathway adapter 151, and an internal pathway adapter 153.

The channelized video streaming setup 101 comprises suitable logic, circuitry and/or code that enable supporting wireless and/or wired pathway channelization via one or more STBs to provide channelized video streaming via one or more audio and/or visual display devices. In an exemplary embodiment of the invention, the channelized video streaming setup 101 also comprises the intranet 111, the Internet 131, the remote PC 119 and the plurality of channelized broadcast video sources 123, which enable providing channelized video streaming via televisions 113 and/or 115.

Each of the televisions 113 and 115 comprises suitable logic, circuitry, and/or code that enable outputting and/or displaying TV like audio/video streams. Each of the local PC 117 and the remote PC 119 comprise a personal computer that is accessible by one or more users. In an embodiment of the invention, the local PC 117 and/or the remote PC 119 are operable, to generate, store into, download into, and/or retrieve from video and/or audio streaming data. The PC 117 also comprises suitable logic, circuitry, and/or code that enable utilizing one or more wireless interfaces, which may comprise, for example, wireless local area network (WLAN) and/or wireless personal area network (WPAN) based interfaces. Exemplary WLAN interface comprise WiFi based connections. Exemplary WPAN interfaces comprise Bluetooth, ZigBee, and/or Ultra-Wideband (UWB) based connections.

The plurality of personal media sources 121 comprises one or more devices that are operable to capture media data. The plurality of personal media sources 121 may comprise, for example, a digital camera, an audio recorder, a smart phone, and/or a camcorder. In an exemplary embodiment, the plurality of personal media sources 121 also comprises suitable logic, circuitry, and/or code that enable utilizing one or more wireless interfaces, which may comprise, for example, WLAN and/or WPAN based interfaces.

The hub 133 comprises suitable logic, circuitry, and/or code that enable network connectivity related operations. For example, the hub 133 may be operable to perform and/or provide connecting, routing, and/or switching operations, via one or more wireless and/or wired interface. In an embodiment of the invention, the hub 133 is operable to provide wireless, optical and/or wired connectivity between various constituent entities within the intranet 111, based on one or more of available WLAN and/or WPAN interfaces.

The first STB 141 comprises suitable logic, circuitry, and/or code that enable performing various processing operations on received TV signals, which may be received from the plurality of channelized broadcast video sources 123, to extract audio/video information that is displayable via audiovisual devices, for example the television 113. The external pathway adapter 151 comprises suitable logic, circuitry, and/or code that enable reception of media streaming data from one or more of a plurality of audio/video sources, via the intranet 111. In an embodiment of the invention, the external pathway adapter 151 comprises suitable logic, circuitry, and/or code that enable utilizing one or more wireless interfaces, which may comprise, for example, wireless local area network (WLAN) and/or wireless personal area network (WPAN) based interfaces. The external pathway channelize 151 also comprises suitable logic, circuitry, and/or code that enable processing the received media streaming data to enable outputting that data via the first STB 141. The second STB 143 and the internal pathway adapter 153 are substantially similar to the first STB 141 and the external pathway adapter 151, respectively. However, the internal pathway adapter 153 is integrated within the second STB 143.

The plurality of channelized broadcast video sources 123 comprises one or more devices that are operable to provide reception of TV feeds and broadcasts, which is communicated by one or more terrestrial, cable, and/or satellite head-ends, for example. In an embodiment of the invention, the plurality of channelized broadcast video sources 123 comprises the cable-fiber infrastructure 125 and the satellite dish 127. The cable-fiber infrastructure 125 comprises suitable logic, circuitry, and/or software that enable, for example, cable-television (CATV) broadcasts. For example, the cable-fiber infrastructure 125 may comprise CATV head-ends and distribution systems that enable forwarding of communication from the CATV head-ends to a plurality of subscribers, wherein the distribution systems comprise, for example, fiber optics and/or coaxial cable networks that enable connectivity between the CATV head-ends and receiving nodes.

The satellite dish 127 comprises suitable logic, circuitry, and/or software that enabled receiving satellite television broadcast. For example, the satellite dish 127 may comprise a dedicated parabolic antenna operable to reflect satellite television signals communicated from satellite television head-ends and to concentrate the reflected satellite signal into a focal point wherein one or more low-noise-amplifiers (LNAs) that are operable to down-convert the received signals to corresponding intermediate frequencies that may be proceed via one or more satellite capable set-top boxes, including, for example, first STB 141 and/or second STB 153.

The intranet 111 comprises suitable logic, circuitry and/or code operable to implement private network connectivity among a plurality of devices and/or entities, based on one or more interfaces and/or protocols. In an embodiment of the invention, the intranet 111 comprises televisions 113 and 115, the local PC 117, the plurality of personal media sources 121, the hub 133, the first STB 141, the second STB 143, and the external pathway adapter 151. Each of the constituent entities in the intranet 111 are enabled to interact with one or more of the remaining entities via any of support networking interfaces in the intranet 111. The network connectivity within the intranet 111 is provided via wired and/or wireless. Exemplary wireless connectivity may comprise wireless local area network (WLAN) interfaces, for example WiFi interfaces, and/or wireless personal area network (WPAN) interface, for example Bluetooth. Entities may interact directly on peer-to-peer basis, or, alternatively, entities may communicate via other entities in the intranet 111. For example, the local PC 117 may interact directly with the external pathway adapter 151 via point-to-point 802.11 based connections, or, alternatively, the local PC 117 may interact with the external pathway adapter 151 via the hub 133.

The internet 131 comprises a system of interconnected computer networks, which enables exchange of information and/or data based on one or more networking standards, including, for example, TCP/IP. The internet 131 enables connectivity among a plurality of private and public, academic, business, and/or government nodes and networks, wherein the physical connectivity may be provided via the Public Switched Telephone Network (PSTN), via copper wires, fiber-optic cables, wireless interface, and other standards-based interfaces. In an exemplary aspect of the invention, the internet 131 may provide connectivity between elements in the intranet 111 and remote sources of media streaming data, including, for example, the remote PC 119.

In operation, the channelized video streaming setup 101 is utilized to enable playing TV broadcasts received from available TV broadcast sources via, for example, one or more of the plurality of channelized broadcast video sources 123. For example, the satellite dish 127 is utilized to enable reception of satellite TV signals transmitted, for example, by satellite TV head-ends. The satellite TV broadcast comprises plurality of satellite TV channels, wherein signals carrying audio/video information corresponding to the various satellite TV channels are, for example, digitally modulated onto RF carriers. The satellite dish 127 is operable to enable receiving and down-converting, via low-noise-amplifiers (LNAs), downlink satellite RF signals. The resulting signals are then communicated to the first STB 141 and/or the second STB 143. The cable-fiber infrastructure 125 is utilized to enable reception of Cable TV (CATV) signals communicated, for example, by CATV head-ends. The CATV broadcast comprises plurality of CATV channels, wherein signals carrying audio/video information corresponding to the various CATV channels are, for example, digitally modulated onto RF carriers. For example, the cable-fiber infrastructure 125 is operable to enable receiving CATV RF signals via available CATV distribution systems, and the received CATV signals are then communicated to the first STB 141 and/or the second STB 143. The first STB 141 and/or the second STB 143 are then utilized to perform necessary processing operations on the received satellite and/or CATV signals. These processing operations comprise, for example, RF reception specific operation, which includes demodulation, filtering, and/or conversion of the received RF signals to enable extracting communicated data. The processing operations also comprise, for example, necessary operations to decrypt and/or to decode utilized transport packets, and/or to perform necessary video and/or audio decoding and processing. The first STB 141 and/or the second STB 143 then processes the extracted audio/video information to enable playing or presentation of corresponding media streams via the televisions 113 and 115, respectively.

In an exemplary embodiment of the invention, the channelized video streaming setup 101 is also utilized to enable playing media streams, from personal sources, via the first STB receiver 141 and/or the second STB receiver 143. Personal media streams, which comprise audio/video information, may be generated in, downloaded into, and/or stored in one or more local and/or remote sources, which comprise, for example, the plurality of personal media sources 121, the local PC 117, and/or the remote PC 119. The personal media streams are communicated, in an exemplary aspect of the invention, to the first STB 141 and/or the second STB 143, to enable playing and/or displaying the audio/video content of the personal media streams via the televisions 113 and 115, respectively.

The external pathway adapter 151 and the internal pathway adapter 153 are utilized to enable reception of the personal media streams via the first STB 141 and the second STB 143, respectively. Wireless and/or wired connections are utilized to communicate the personal media streams, directly and/or indirectly, from the one or more of the plurality of personal media sources 121, the local PC 117, and/or the remote PC 119, to the external pathway adapter 151 and/or the internal pathway adapter 153. For example, WLAN and/or WPAN based connections are utilized to enable Local PC 117 to communicate personal media streams directly to the external pathway adapter 151.

Alternatively, the hub 133 is utilized to route personal media streams into the external pathway adapter 151 and/or the internal pathway adapter 153. For example, the hub 133 may be utilized to receive the personal media streams wirelessly from the plurality of personal media sources 121 and/or the local PC 117, and/or via wire-lines, and through the internet 131, from the remote PC 119. The hub 133 then communicates the received personal media streams via wireless and/or wire-line connections to the external pathway adapter 151 and/or the internal pathway adapter 153. The external pathway adapter 151 and/or the internal pathway adapter 153 are utilized to process the received personal media stream to enable feeding them via the first STB 141 and/or the second STB 143, respectively. The processing of the received media stream, via the external pathway adapter 151 and/or the internal pathway adapter 153, comprise performing various operations, including, but not limited, necessary RF reception related operations, necessary security and/or decryption operations, and/or any necessary audio/video processing operations.

In an exemplary aspect of the invention, the received media streams are channelized, wherein the audio/video content of the received media streams is packaged based on one of supported TV-based standards to imitate TV broadcasts, which are then fed into the first STB 141 and/or the second STB 143. The resulting TV-like channelized media streams are either feed directly into the STBs, or are RF modulated to imitate RF signals receivable from any supported TV head-ends, including, for example, satellite TV and/or CATV head-ends. The channelization of media streams enables viewing of these streams as TV channels that are assigned values beyond the range otherwise available via the received TV feeds. Alternatively, the personal media streams are channelized to replace used channels in the TV feeds, wherein the preemption of used channels is determined based on predefined settings and/or criteria, and/or based on user command via user interfaces. To facilitate the reception of personal media streams, the external pathway adapter 151 and/or the internal pathway adapter 153 utilize, for example, server-like functionality, which enables users to interact with the external pathway adapter 151 and/or the internal pathway adapter 153, via client-like functionality.

The users may establish, for example, peer-to-peer connections between personal media streams sources and the external pathway adapter 151 and/or the internal pathway adapter 153. The peer-to-peer connections are utilized, for example, to request personal media stream play services and/or to submit the personal media streams that are to be played via the external pathway adapter 151 and/or the internal pathway adapter 153. Webpage-based interfaces and/or application programming interface (API) that are specific to the server functionality running in the external pathway adapter 151 and/or the internal pathway adapter 153, for example, can also be utilized to enable interaction by users at the client-end.

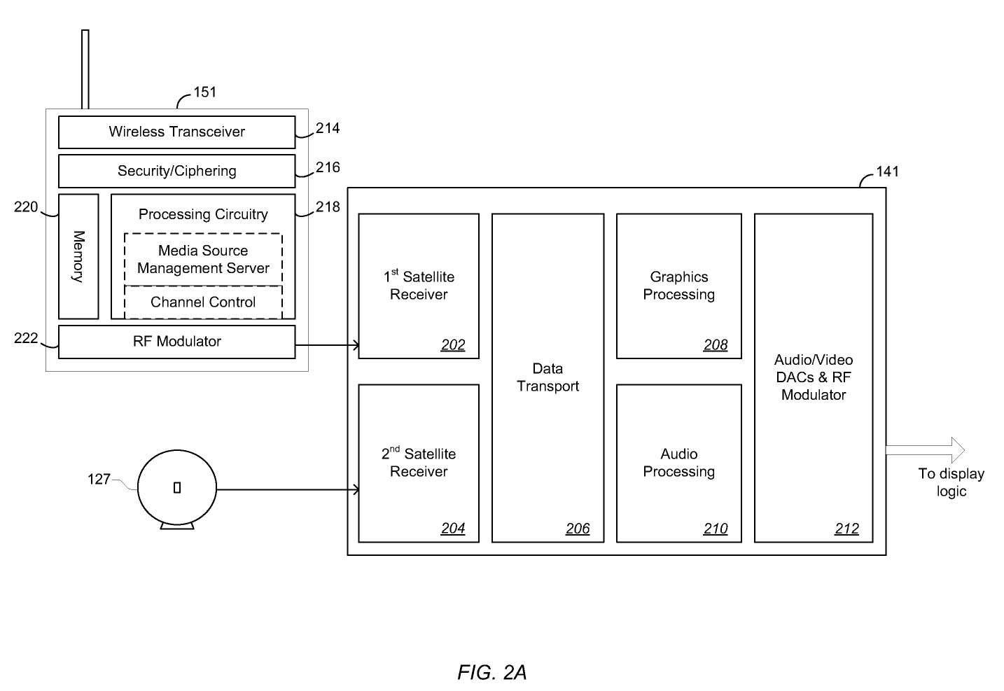

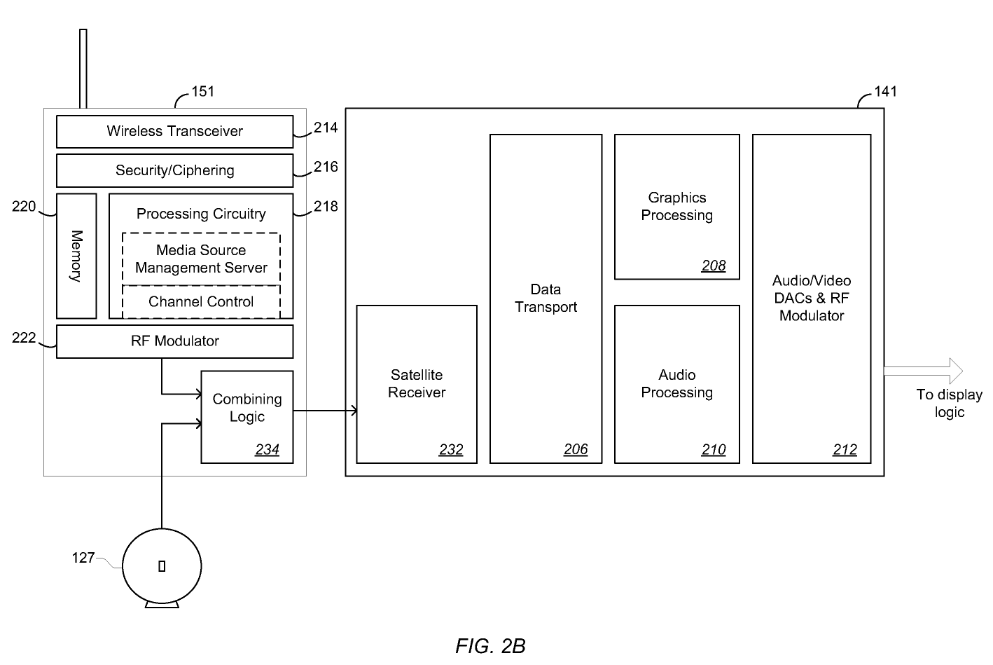

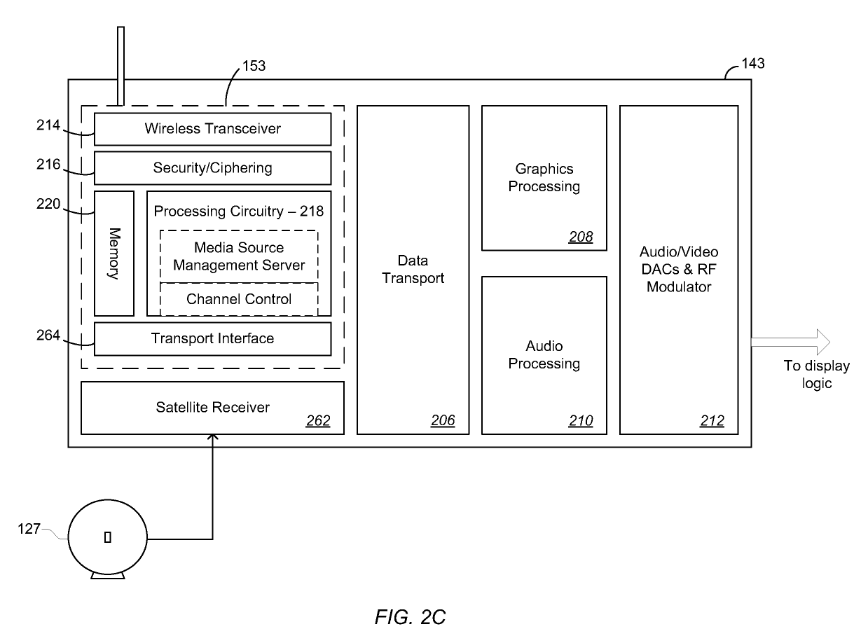

FIG. 2A is a block diagram that illustrates an external wireless adapter that is utilized to enable channelized video streaming processing via a satellite set-top box (STB) that support two satellite feeds, in accordance with an embodiment of the invention. Referring to FIG. 2A, there is shown the satellite dish 127, the first STB 141, the external pathway adapter 151, a first satellite receiver 202, a second satellite receiver 204, a data transport block 206, a graphic processing block 208, an audio processing block 210, a audio/video digital-to-analog converters (DACs) and RF modulator block 212, a wireless transceiver 214, a security/ciphering block 216, a processing circuitry 218, a memory 220, and an RF modulator 222.

The first satellite receiver 202 comprises suitable logic, circuitry, and/or code that enable processing of received satellite based signals via, for example, the satellite dish 127. The first satellite receiver 202 is operable, for example, to enable filtering, amplification, demodulate, and/or direct or intermediate conversion of received signals to baseband frequency signals that are processed via one or more baseband processors to enable receiving satellite TV signals from a specific satellite TV provider. In some instances, the first satellite receiver 202 enables analog-to-digital conversion of baseband signal components before transferring the components to digital baseband processors. The second satellite receiver 204 is substantially similar to the first satellite receiver 202; however, the logic, circuitry and/or software of the second satellite receiver 204 is modified to enable supporting different satellite TV providers. In an exemplary aspect of the invention, a single satellite dish, for example the satellite dish 127, is operable in conjunction with the first satellite receiver 202 and the second satellite receiver 204 to provide multiple satellite signal feeds by use of different LNAs within the satellite dish 127. Alternatively, different satellite dishes, for example two instances of the satellite dish 127, may be utilized to provide different satellite TV feeds to each of the first satellite receiver 202 and the second satellite receiver 204.

The data transport block 206 comprises suitable logic, circuitry, and/or code that enable performing data transport processing functionality. For example, the data transport block 206 may be operable to enable processing transport data packets received via TV broadcast signals, to enable extraction of data encapsulated in the transport data packets based on one or more transport protocols. The extracted data may comprise audio and/or video information pertaining to one or more TV channels broadcasted by TV head-ends.

The graphic processing block 208 comprises suitable logic, circuitry, and/or code that enable performing video processing operations on received data. For example, the graphic processing block 208 may be operable to perform necessary video decompression and/or decoding operation, based on one or more algorithms, to translate the video information carried via received TV signals.

The audio processing block 210 comprises suitable logic, circuitry, and/or code that enable performing audio processing operations on received data. For example, the audio processing block 210 may be operable to perform necessary audio decoding operations, based on one or more algorithms, which decodes and processes the audio information carried via the received TV signals. The audio/video DACs and RF modulator block 212 comprises suitable logic, circuitry, and/or code that enable generating output stream that enable playing and/or displaying, via dedicated entities, the audio and/or video information extracted from, for example, received TV signals via the graphics processing block 208 and/or the audio processing block 210. For example, the audio/video DACs and RF modulator block 212 may be operable to enable playing/displaying the audio/video content of received TV signals via the televisions 113 and/or 115.

The wireless transceiver 214 comprises suitable logic, circuitry, and/or code that enable processing of RF signals, transmitted and/or received via the external pathway adapter 151, based on one or more wireless interfaces. The wireless transceiver 214 may be operable, for example, to amplify, filter, modulate/demodulate, and/or up-convert/down-convert baseband signals to and/or from RF signals to enable transmitting and/or receiving RF signals based on one or more WLAN and/or WPAN interfaces. In this regard, the wireless transceiver 214 is operable to generate signals, such as local oscillator signals, for the reception, transmission and/or processing of RF signals. The wireless transceiver 214 may also perform necessary conversions between received RF signals and baseband frequency signals that may be processed via baseband processing logic, for example. The wireless transceiver 214 may perform direct or intermediate conversions between the received and/or transmitted RF signals, and baseband frequency signals, for example. In some instances, the wireless transceiver 214 performs analog-to-digital and/or digital-to-analog conversion on baseband signal components to enable processing via digital baseband processors. The security/ciphering block 216 comprises suitable logic, circuitry, and/or code that enable performing security access and/or decryption/encryption operations on signals received and/or transmitted via the wireless transceiver 214.

The processing circuitry 218 comprises suitable logic, circuitry, and/or code that enable that enable performing processing operations that enable the STBs to play personal media streams. For example, the processing circuitry 218 may be operable to enable reception of personal media streams via the wireless transceiver 214, to enable processing the received personal media streams to be outputted via the first STB 141. The processing circuitry 218 comprises a channel control functionality that enable channelization of received personal streams, wherein the audio/video content of the received personal media streams is processed, based on appropriate TV-based standards, to simulate audio/video information carried via TV broadcasts that are supported via the STBs. The processing circuitry 218 also comprises media source management server functionality to enable interactions with the external pathway adapter 151, to request pathway services and/or to establish routing paths for personal media streams from local and/or remote sources to the external pathway adapter 151, via the wireless transceiver 214, for example. The media source management server functionality may provide, for example, webpage-based interfaces and/or dedicated APIs that are utilized to enable interaction with the external pathway adapter 151. The memory 220 comprises suitable logic, circuitry, and/or code that enable storage of data, code, and/or other information. For example, the memory 220 may be utilized for buffering received personal media streams, for storing instructions and/or configuration information, and/or to enable temporary storage and/or buffering during operations by other entities in the external pathway adapter 151. The RF modulator 222 comprises suitable logic, circuitry, and/or code that enable performing necessary RF modulation of the resulted channelized media streams to simulate TV signals otherwise receivable via the STBs.

In operation, the satellite dish 127, the first STB 141, the external pathway adapter 151 are utilized to enable playing TV broadcasts received from, for example, satellite TV head-ends, and to enable playing media streams, from personal sources, substantially as described in FIG. 1.

The satellite dish 127 enables receiving satellite TV broadcast, from satellite TV head-ends for example. The received satellite TV signals are fed via a dedicated input into the second satellite receiver 204, wherein the received satellite TV signals are processed to extract transport data packets carried via the satellite TV signals. The transport data packets are then processed via the data transport block 206, and data corresponding to the audio/video content is extracted. The graphic processing block 208 performs necessary video related decoding operations, and the audio processing block 210 performs necessary audio decoding operations on the data. The audio/video DACs & RF modulator generates audiovisual streams that are sent to the display logic for playback operations.

The external pathway adapter 151 is utilized to enable playing media streams via the first STB 141. The media source management server functionality in the processing circuitry 218 in the external pathway adapter 151 enables establishing server-like operations, wherein one or more users can interact with the external pathway adapter 151, via corresponding client-like functionality. These interactions may be based on webpage-based interfaces, HTTP for example, and/or based on dedicated APIs. The users may then be able to request personal media stream play services and/or to submit the personal media streams that are to be played via the external pathway adapter 151. The personal media streams are forwarded to the external pathway adapter 151, via a wireless interface for example, wherein the wireless transceiver 214 is utilized to enable reception of the personal media streams.

In instances where specific access security measures and/or encryption are utilized during interactions with the external pathway adapter 151 and/or during forwarding of the personal media streams, the security/ciphering block 216 is utilized to perform necessary security operations and/or to perform any necessary deciphering on received messaging via the wireless transceiver 214. The received personal media streams are then processed, via the processing circuitry 218, wherein channelization of the personal media streams is performed. For example, channelization is performed to generate audio/video steams that simulate data communicated via TV channels based on supported TV broadcast type. The channel control functionality in the processing circuitry 218 enables channelizing of the received personal media streams to simulate satellite TV channels. The resultant channelized media stream is then RF modulated via the RF modulator 222, and then fed into a dedicated input corresponding to the first satellite receiver 202, where the first STB 141 may process the received feed substantially similar to satellite TV signals received via the second satellite receiver 204.

In an exemplary aspect of the invention, the media source management server functionality also enables users to continue interacting with the external pathway adapter 151 and/or the first STB 141 to communicate play-related commands and/or requests, via wireless connections, which are supported via the wireless transceiver 214 in the external pathway adapter 151.

FIG. 2B is a block diagram that illustrates an external wireless adapter that is utilized to enable channelized video streaming processing via a satellite set-top box (STB) that support a single satellite feed, in accordance with an embodiment of the invention. Referring to FIG. 2B, there is shown the satellite dish 127, the first STB 141, the external pathway adapter 151, the data transport block 206, the graphic processing block 208, the audio processing block 210, the audio/video digital-to-analog converters (DACs) and RF modulator block 212, the wireless transceiver 214, the security/ciphering block 216, the processing circuitry 218, the memory 220, the RF modulator 222, the satellite receiver 232, and a combining logic 234.

The satellite receiver 232 is substantially similar to the first satellite receiver 202 and/or the second satellite receiver 204, as described in FIG. 2A.

The combining logic 234 comprises suitable logic, circuitry, and/or code that enable that enable generating a single output feed based on a plurality of input feeds. The combining logic 234 may be, for example, operable to generate single output feed of TV-based signaling from two different input feeds of TV-like signals, including a first feed from the satellite dish 127 and a second feed generated within the external pathway adapter 151. The combining logic 234 may comprise, for example, selection and/or multiplexing logic to enable switching and/or choosing between the two or more input feeds. The combining logic 234 may be operable to combine resultant channelized media streams generated via the external pathway adapter 151 onto the satellite TV feed received from the satellite dish 127.

In operation, the satellite dish 127, the first STB 141, the external pathway adapter 151 are utilized to enable playing TV broadcasts received from, for example, satellite TV head-ends, and to enable playing media streams, from personal sources, substantially as described in FIGS. 1 and 2A. However, since the first STB 141 in the current embodiment of the invention comprises only a single satellite receiver, only one satellite feed input is supported. Consequently, the combining logic 234 enables combining generated channelized media streams and satellite TV feed receivable via the satellite dish 127. In an exemplary aspect of the invention, the combining logic 234 is used to switch between the satellite TV feed, receivable via the satellite dish 127, and personal media streams, receivable and channelized via the external pathway adapter 151. In an alternative embodiment, the combining logic 234 is utilized to combine personal media streams generated via the external pathway adapter 151 onto the satellite TV feed received from the satellite dish 127. The channelizing of personal media streams receivable via the external pathway adapter 151 comprises assigning the received personal media streams unused channels in the satellite TV feed. For example, wherein the satellite TV feed comprises only channels 1-1000, for example, channelized media streams are combined, via the combining logic 234, and are assigned channels 1001-1020, for example. Consequently, the output feed, from the combining logic 234, simulates a satellite TV feed with channel range of 1-1020. In an embodiment of the invention, personal media streams receivable via the external pathway adapter 151 and/or internal pathway adapter 153 are channelized to preempt used satellite and/or cable channels. For example, where the satellite feed comprises channels 1-1000, channelized media streams are combined, via the combining logic 234, into the satellite feed and are assigned channels 980-1000. The assigned channels, however, need not occupy sequential range. The assignment of personal media streams to used channels is performed, for example, based on predetermined preferences, settings and/or criteria; and/or based on user commands that are communicated, for example, via interactive interface that enables the user to specify channels that are allocated to personal media stream feeds prior to and/or during active satellite feeds.

While the combining logic 234 is shown integrated within the external pathway adapter 151 in the current embodiment described in FIG. 2B, the invention need not limited as such. In another embodiment, an external device and/or system operable to perform the functions of the combining logic 234 is used to combine and/or multiplex the channelized personal media stream and the broadcast TV feed.

FIG. 2C is a block diagram that illustrates an internal wireless adapter that is utilized to enable channelized video streaming processing via a satellite set-top box (STB), in accordance with an embodiment of the invention. Referring to FIG. 2C, there is shown the satellite dish 127, the second STB 143, the internal pathway adapter 153, the data transport block 206, the graphic processing block 208, the audio processing block 210, the audio/video digital-to-analog converters (DACs) and RF modulator block 212, the wireless transceiver 214, the security/ciphering block 216, the processing circuitry 218, the memory 220, a satellite receiver 262, and a transport interface block 264.

The satellite receiver 262 is comprised substantially similar to the first satellite receiver 202 and/or the second satellite receiver 204, as described with respect to FIG. 2A.

The transport interface block 264 comprises suitable logic, circuitry, and/or code that enable that enable processing channelized received personal media streams to generate data packets that are processed via the second STB 143. For example, transport interface block 264 is operable to package received personal media streams to simulate data packets otherwise receivable via supported TV broadcast in the second STB 143, which is processed via the data transport block 206.

In operation, the satellite dish 127, the second STB 143, and the internal pathway adapter 153 are utilized to enable playing TV broadcasts received from, for example, satellite TV head-ends, and to enable playing media streams, from personal sources, substantially as described in FIG. 1. The satellite dish 127 enables receiving satellite TV broadcast, from satellite TV head-ends for example. The received satellite TV signals are fed via a dedicated input into the satellite receiver 232, wherein the received satellite TV signals are processed to extract transport data packets carried via the satellite TV signals. The transport data packets are then processed via the data transport block 206, and data corresponding to the audio/video content is extracted. The graphic processing block 208 performs necessary video related decoding operations, and the audio processing block 210 performs necessary audio decoding operations on the data. The audio/video DACs & RF modulator generates audiovisual streams that are sent to the display logic for playback operations.

The internal pathway adapter 153 is operable to enable use of the playing media streams via the second STB 143, substantially similar to use of the external pathway adapter 151 to enable playing via the first STB 141, as described with respect to FIGS. 2A and 2B. However, because the internal pathway adapter 153 is integrated with the second STB 143, channelized personal media streams that are received from local and/or remote personal sources via the wireless transceiver 214 need not be RF modulated to simulate TV broadcast that is inputted into the second STB 143. Instead, once received personal media streams are processed and channelized, via the processing circuitry 218, the resultant channelized media streams are sent through the transport interface block 264. The transport interface block 264 then processes the channelized media streams to package these streams into data packets that are typically received, via supported TV broadcast, and processed via second STB 143. For example, transport interface block 264 packages the received and channelized personal media streams into data packet that simulate data packets that can be processed via the data transport block 206. The resultant data packets are then forwarded to the data transport block 206, wherein the second STB 143 is enabled to process these packets as though they were received via support TV broadcasts.

In an alternative embodiment of the invention, where the second STB 143 is limited to processing a single TV input feed, the channelized and/or packetized personal media streams may be combined with the TV input feed received via the satellite receiver 262 via combining logic. The combining logic may be substantially similar to the combining logic 234, as described with respect to FIG. 2B, where switching and/or combining operation are performed on the TV feed received via the satellite receiver 262 and the personal media streams received via the internal pathway adapter 153.

While the current invention has been described with respect to FIGS. 2A, 2B, and 2C with regard to STBs that are operable to enable reception of satellite TV broadcast, the invention may be implemented similarly with regard to other types of TV broadcasts. For example, various other embodiments of the invention that are substantially similar to the embodiments of the invention described with respect to FIGS. 2A, 2B, and 2C are utilized to enable supporting playing of personal media streams via STBs that are operable to receive CATV broadcasts. Some changes and/or limitations, however, have to be considered when modifying the described embodiment to enable supporting other types of TV broadcasts. For example, because some CATV providers do not allow for multiple cable inputs in their CATV-capable STBs, only embodiments of the invention that enable combining the personal media stream onto the TV broadcasts to generate a single input into the STBs are used.

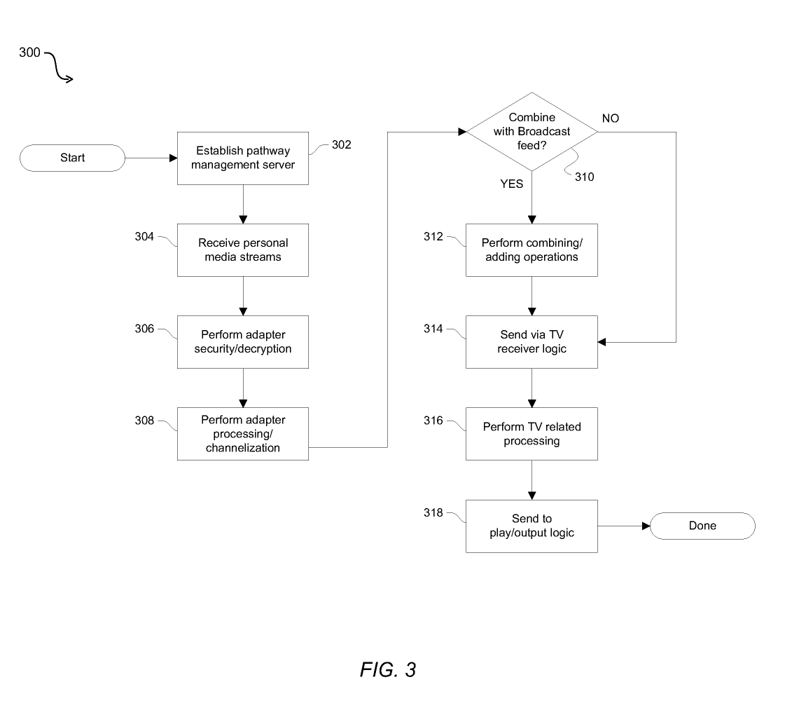

FIG. 3 is a flow chart that illustrates use of channelized video streaming system in supporting wireless feed via set-top boxes, in accordance with an embodiment of the invention. Referring to FIG. 3, there is shown a flow chart 300 comprising a plurality of exemplary steps, which are executable to enable channelized pathway support of personal media streams via STBs.

In step 302, a pathway management server operation is performed. For example, the media source management server functionality via the processing circuitry 208 in the external pathway adapter 151 and/or the internal pathway adapter 153, is utilized to enable user interactions to request pathway services and/or to establish routing paths for personal media streams from local and/or remote sources. These interactions are communicated, via the media source management server functionality, based on webpage-based interfaces and/or dedicated APIs. In step 304, personal medial streams are received. For example, the wireless transceiver 214 is operable in the pathway adapter 151 and/or the internal pathway adapter 153 to enable receiving personal media streams over supported wireless interfaces, wherein the personal media streams are communicated directly from personal media sources and/or indirectly, via the hub 133 for example.

In step 306, necessary security/ciphering operations are performed in the pathway adapters. For example, the security/ciphering block 216, in the external pathway adapter 151 and/or the internal pathway adapter 153, is utilized to perform necessary security operations and/or to perform any necessary deciphering on messaging received via the wireless transceiver 214 to authenticate the user communicating the received messaging and/or to enable extracting data carrying the personal media stream within the received messaging. In step 308, the pathway adapter processing operations are utilized, to enable feeding of the received personal media streams via STBs. For example, the processing circuitry 218, and in particular the channel control functionality, is utilized to enable processing received media streams in the external pathway adapter 151 and/or the internal pathway adapter 153.

Channelization of the received personal media streams is performed, for example, to generate audio/video steams that simulate data communicated via TV channels based on supported TV broadcasts. In step 310, a determination whether to combine the received personal media streams with TV feed from TV broadcast is performed. In instances where the STB is limited to processing a single TV input feed, due to hardware/logic limitations and/or to provider requirements, the channelized and/or packetized personal media streams are combined with the TV input feed received from TV broadcast head-ends. In instances where it is determined that received personal media streams are to be combined with TV feed from TV broadcasts, the exemplary steps proceed to step 312. In step 312, the channelized received personal media streams are combined with TV feed from TV broadcasts. For example, the combining logic 234 is utilized to perform combining operation, substantially as described with respect to, for example, FIG. 2B.

Returning to step 310, in instances where it may be determined that received personal media streams are to be combined with TV feed from TV broadcasts, the exemplary steps may proceed to step 314. In step 314, the channelized received personal media streams are fed into the STBs. For example, personal media streams, received and channelized via the pathway adapter 151 and/or the internal pathway adapter 153, are fed, separately or in combination with TV feeds received from the channelized broadcast video sources 123, into the first STB 141 and/or the second STB 143. In step 316, the STBs process the channelized personal media streams as if they were TV feeds from broadcast sources. For example, the data transport block 206, the graphic processing block 208, the audio processing block 210, and the audio/video DACs and RF modulator block 212 are utilized to process the personal media streams, received and channelized via the pathway adapter 151 and/or the internal pathway adapter 153, to generate audiovisual streams that are playable via display logic, for playback operations. In step 318, the generated audiovisual streams are sent and played via the display logic.

Various embodiments of the invention may comprise a method and system for wireless pathway adapter support via set-top boxes. The external pathway adapter 151 and/or the internal pathway adapter 153 are utilized to enable playing personal media streams via the first STB 141 and/or the second STB 143, respectively. The personal media streams are forwarded from local and/or remote sources, including, for example, the personal computer (PC) 117, the remote PC 119, and/or the plurality of personal media sources 121. The personal media sources communicate directly with the external pathway adapter 151 and/or the internal pathway adapter 153, and/or indirectly, via the hub 133 for example. The wireless transceiver 214 enables supporting a plurality of wireless interfaces via the external pathway adapter 151 and/or the internal pathway adapter 153, including, for example, WLAN and/or WPAN based interfaces.

The external pathway adapter 151 and/or the internal pathway adapter 153 perform security and/or deciphering of received messaging, carrying the personal media streams, if necessary. The external pathway adapter 151 and/or the internal pathway adapter 153 process the received personal media streams to enable playing them seamlessly via the first STB 141 and/or the second STB 143, wherein said processing comprises channelizing the received media streams to simulate TV channels in any of TV broadcasts receivable via the first STB 141 and/or the second STB 143. The channelized personal media streams are feed directly and separately into the first STB 141 and/or the second STB 143, and/or combined and/or multiplexed with TV broadcast feeds received by the first STB 141 and/or the second STB 143. The switching between and/or combining of the channelized personal media streams and TV broadcast feeds is performed within pathway adapters, external to the pathway adapters but within the STBs, and/or external to both the STBs and the pathway adapters, via a dedicated device for example. The media source management server functionality enables interactions with the external pathway adapter 151 and/or the internal pathway adapter 153, to request pathway services and/or to establish routing paths for personal media streams from local and/or remote sources to the external pathway adapter 151 and/or the internal pathway adapter 153. The user interactions, via the media source management server functionality, may be based on webpage-based interfaces and/or dedicated APIs.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for wireless pathway adapter support via set-top boxes.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for video processing, the method comprising:
receiving a personal media stream via a pathway adapter that is directly coupled to a set-top box receiver; and
processing said received personal media stream via said pathway adapter to enable seamless outputting of said received personal media stream via said set-top box receiver.

2. The method according to claim 1, comprising channelizing said received personal media stream via said pathway adapter to enable said seamless outputting of said received personal media stream via said set-top box receiver, wherein said channelization simulates reception of audiovisual signaling via television channels.

3. The method according to claim 1, wherein said set-top box receiver enables reception of satellite, cable, and/or fiber based television broadcasts.

4. The method according to claim 1, wherein said pathway adapter comprises one or more optical interfaces, one or more wireless interfaces and/or one or more wired interfaces to enable said reception of said personal media stream from local and/or remote sources.

5. The method according to claim 4, wherein said one or more wireless interfaces comprise WWAN, WLAN, WPAN, and/or device-specific interfaces.

6. The method according to claim 1, wherein said pathway adapter is integrated within said set-top box receiver.

7. The method according to claim 1, comprising switching between said personal media stream and a television broadcast feed receivable via said set-top box receiver.

8. The method according to claim 1, comprising combining said personal media stream onto a television broadcast feed receivable via said set-top box receiver.

9. The method according to claim 8, wherein said combining comprises integration of said personal media stream into said television broadcast feed utilizing unassigned television channels in said television broadcast feed.

10. The method according to claim 1, comprising performing user access operations via a management server in said pathway adapter.

11. The method according to claim 10, wherein said management server enables interactions with said pathway adapter via webpage-based interfaces and/or dedicated application protocol interfaces (APIs).

12. The method according to claim 10, wherein said user access operations comprise security and/or decryption operations.

13. A system for video processing, the system comprising:
one or more circuits in a pathway adapter; said one or more circuits enable reception of personal media stream via a pathway adapter that is directly coupled to a set-top box receiver; and
said one or more circuits enable processing of said received personal media stream via said pathway adapter to enable seamless outputting of said received personal media stream via said set-top box receiver.

14. The system according to claim 13, wherein said one or more circuits enable channelization of said received personal media stream via said pathway adapter to enable said seamless outputting of said received personal media stream via said set-top box receiver, wherein said channelization simulates reception of audiovisual signaling via television channels.

15. The system according to claim 13, wherein said set-top box receiver enables reception of satellite, cable, and/or fiber based television broadcasts.

16. The system according to claim 13, wherein said one or more circuits enable supporting of a plurality of wireless and/or wired interfaces via said pathway adapter to enable said reception of said personal media stream from local and/or remote sources.

17. The system according to claim 16, wherein said plurality of wireless interfaces comprise WWAN, WLAN, WPAN, and/or device-specific interfaces.

18. The system according to claim 13, wherein said pathway adapter is integrated within said set-top box receiver.

19. The system according to claim 13, wherein said one or more circuits, and/or circuitry external to said pathway adapter, enable switching between said personal media stream and a television broadcast feed receivable via said set-top box receiver.

20. The system according to claim 13, wherein said one or more circuits, and/or circuitry external to said pathway adapter, enable combining said personal media stream and a television broadcast feed receivable via said set-top box receiver.

21. The system according to claim 20, wherein said combining comprises integration of said personal media stream into said television broadcast feed utilizing unassigned television channels in said television broadcast feed.

22. The system according to claim 13, wherein said one or more circuits enable performing user access operations via a management server via said pathway adapter.

23. The system according to claim 22, wherein said management server enables interactions with said pathway adapter via webpage-based interfaces and/or dedicated application protocol interfaces (APIs).

24. The method according to claim 22, wherein said user access operations comprise security and/or decryption operations.
